(19) United States
(12) Patent Application Publication
(10) Pub. No.: US 2020/0380700 A1
(43) Pub. Date: Dec. 3, 2020

(54) METHODS AND APPARATUS FOR DETECTING MOTION ESTIMATION

(71) Applicant: QUALCOMM Incorporated, San Diego, CA (US)

(72) Inventor: Samuel Benjamin HOLMES, Sterling, MA (US)

(21) Appl. No.: 16/430,363

(22) Filed: Jun. 3, 2019

(51) Int. Cl. G06T 7/246; G06T 1/20; G06T 3/20

(52) U.S. Cl. CPC G06T 7/248; G06T 3/20; G06T 1/20

(57) ABSTRACT

The present disclosure relates to methods and apparatus for graphics processing. The apparatus can determine whether motion estimation for image data in a frame is greater than or equal to a motion estimation threshold. A plurality of motion vectors in the frame can provide the motion estimation, where the motion vectors can include a first motion vector and a second motion vector. Further, the apparatus can compare the first motion vector and the second motion vector when the motion estimation is greater than or equal to the motion estimation threshold, where the first motion vector includes a first motion value and the second motion vector includes a second motion value. Additionally, the apparatus can determine whether a difference between the first motion value and the second motion value is greater than or equal to a motion value threshold. The apparatus can also save resources by rendering visible sub-primitives.

### TECHNICAL FIELD

The present disclosure relates generally to processing systems and, more particularly, to one or more techniques for graphics processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the advent of wireless communication and smaller, handheld devices, there has developed an increased need for improved graphics processing.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. This summary presents some concepts of one or more aspects in a simplified form as a prelude to the more detailed description that is presented later.

In an aspect of the disclosure, a method, a computer-readable medium, and an apparatus are provided. The apparatus may be a graphics processing unit (GPU). In some aspects, the apparatus can be configured to determine whether motion estimation for image data in a frame is greater than or equal to a motion estimation threshold. A plurality of motion vectors in the frame can provide the motion estimation, where the plurality of motion vectors can include a first motion vector and a second motion vector. Further, the apparatus can be configured to compare the first motion vector and the second motion vector when the motion estimation is greater than or equal to the motion estimation threshold, where the first motion vector can include a first motion value and the second motion vector includes a second motion value. Additionally, the apparatus can be configured to determine whether a difference between the first motion value and the second motion value is greater than or equal to a motion value threshold.

In some aspects, when determining whether the motion estimation is greater than or equal to a motion estimation threshold the apparatus can be further configured to determine a motion value for each of the plurality of motion vectors in the frame. Also, when comparing the first motion vector and the second motion vector the apparatus can be further configured to compare each of the plurality of motion vectors in the frame to at least one neighboring vector that is adjacent to the vector. In some aspects, the apparatus can be configured to estimate a motion value for each of the plurality of motion vectors in the frame. In further aspects, the apparatus can be configured to generate the plurality of motion vectors in the frame.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU in accordance with one or more techniques of this disclosure.

FIGS. 3A and 3B illustrate example content for motion vector determination in example frames in accordance with one or more techniques of this disclosure.

FIG. 4 illustrates example motion vectors in an example frame in accordance with one or more techniques of this disclosure.

FIGS. 5A-5C illustrate example motion vectors in accordance with one or more techniques of this disclosure.

FIGS. 6A and 6B illustrate example frame extrapolations in accordance with one or more techniques of this disclosure.

FIG. 7 illustrates an example flowchart of an example method in accordance with one or more techniques of this disclosure.

FIG. 8 illustrates example motion vectors in an example frame in accordance with one or more techniques of this disclosure.

FIG. 9 illustrates an example flowchart of an example method in accordance with one or more techniques of this disclosure.

### DETAILED DESCRIPTION

Aspects of the present disclosure can introduce detailed visibility information, such as by using the visibility information of sub-primitives or tessellated primitives. For instance, if the detailed visibility information is utilized, e.g., by using the sub-primitives or tessellated primitives, then GPUs herein can identify which sub-primitives are visible or not visible. By doing so, aspects of the present disclosure can determine or generate a visibility stream for sub-primitives, i.e., a sub-primitive visibility stream. Accordingly, during the rendering process, GPUs herein may render the sub-primitives that are visible. For example, GPUs herein can skip rending the sub-primitives that are not visible. As such, aspects of the present disclosure can save or conserve rendering or processing resources by rendering or processing the sub-primitives or tessellated primitives that are visible.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

As used herein, instances of the term “content” may refer to graphical content or display content. In some examples, as used herein, the term “graphical content” may refer to a content generated by a processing unit configured to perform graphics processing. For example, the term “graphical content” may refer to content generated by one or more processes of a graphics processing pipeline. In some examples, as used herein, the term “graphical content” may refer to content generated by a graphics processing unit. In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

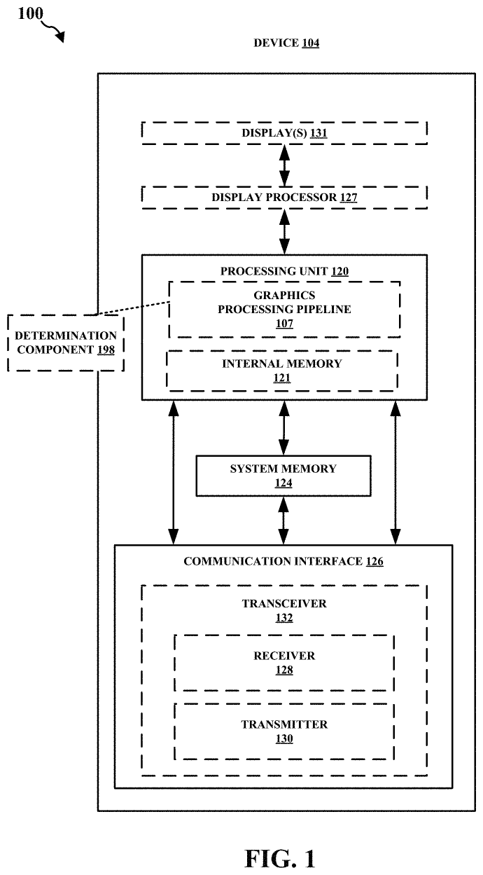

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 may be communicatively coupled to each other over the bus or a different connection.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the graphics processing pipeline 107 may include a determination component 198 configured to determine whether motion estimation for image data in a frame is greater than or equal to a motion estimation threshold. A plurality of motion vectors in the frame can provide the motion estimation, where the plurality of motion vectors can include a first motion vector and a second motion vector. Further, the determination component 198 can be configured to compare the first motion vector and the second motion vector when the motion estimation is greater than or equal to the motion estimation threshold, where the first motion vector can include a first motion value and the second motion vector includes a second motion value. Additionally, the determination component 198 can be configured to determine whether a difference between the first motion value and the second motion value is greater than or equal to a motion value threshold. In some aspects, when determining whether the motion estimation is greater than or equal to a motion estimation threshold the determination component 198 can be further configured to determine a motion value for each of the plurality of motion vectors in the frame. Also, when comparing the first motion vector and the second motion vector the determination component 198 can be further configured to compare each of the plurality of motion vectors in the frame to at least one neighboring vector that is adjacent to the vector. In some aspects, the determination component 198 can be configured to estimate a motion value for each of the plurality of motion vectors in the frame. In further aspects, the determination component 198 can be configured to generate the plurality of motion vectors in the frame.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein.

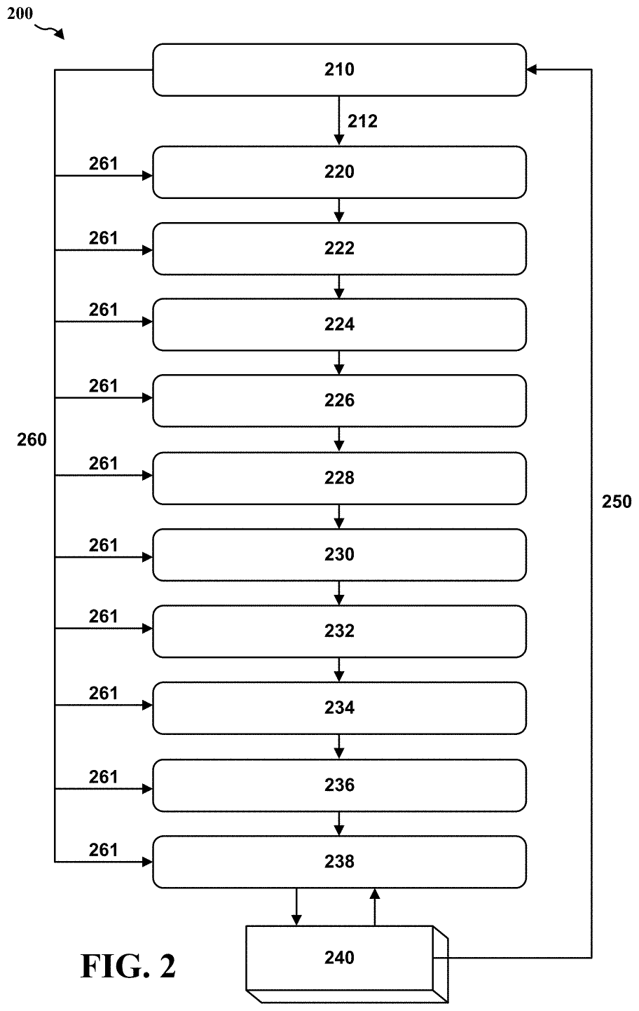

FIG. 2 illustrates an example GPU 200 in accordance with one or more techniques of this disclosure. As shown in FIG. 2, GPU 200 includes command processor (CP) 210, draw call packets 212, vertex fetcher (VFD) 220, vertex shader (VS) 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

GPUs can process multiple types of data in a GPU pipeline. For instance, in some aspects, a GPU can process two types of data or data packets, e.g., context register packets and draw call data. As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can be structured as follows: context register of context N, draw call(s) of context N, context register of context N+1, and draw call(s) of context N+1.

Motion estimation is the process of analyzing multiple two dimensional (2D) images and producing motion vectors which describe the movement of regions from one image to the other. For example, motion estimation is a method of estimating the motion experienced during consecutive frames, e.g., during virtual reality (VR), augmented reality (AR), or gaming applications. Essentially, motion estimation produces motion vectors that can describe how objects move within certain sections of an image. Motion vectors have a variety of uses including video compression, post-processing effects, such as motion blur, and frame extrapolation or interpolation. In order to lighten the rendering workload on a GPU, VR or AR systems can utilize motion estimation in order to extrapolate frames from previously rendered content. By doing so, this may allow the GPU to render frames at a reduced rate, where the extrapolated frames are displayed to the user in the place of rendered content. Motion estimation can be useful because in VR or AR systems there is a strong drive to reduce the rendering workload, e.g., at the GPU.

Frame extrapolation is a method to increase the frame rate of VR/AR and gaming applications. For instance, frame extrapolation can estimate the motion between two previously rendered frames and extrapolate a new frame based on the detected motion. In some aspects, when extrapolating frames, instead of rendering at a particular frame rate, aspects of the present disclosure can render at a lower frame rate, perform motion estimation on the rendered frames, and then use the motion estimation to extrapolate content. This content can then be interspersed with other content to produce a higher frame rate.

In some aspects, motion estimation may be difficult to estimate. For example, estimating motion with a significant amount of corrupted data may be difficult. Further, motion estimation can be inaccurate. For instance, some applications of motion estimation, e.g., common application content or fade transitions, can cause large amounts of incorrect motion estimation. Fade transitions in particular can produce an increased amount of corruption, as the content is fading between two still images. For instance, in some aspects of fade transitions, there may be no motion, but the fade transition can cause a flux across an entire image, such that the motion estimation may identify as incorrect motion.

As mentioned above, fade transitions can result in inaccurate motion estimation. In some instances, fade transitions can cause a lack of overall coherency within a frame. For example, due to the hierarchal nature of motion estimation, inaccurate or invalid data can appear “chunky” or coherent at small scales. In some aspects of fade transitions, even legitimate motion may not be a good case for extrapolation. In some instances, color can be used to estimate the direction of the motion, e.g., in a fade transition. Using color to estimate the direction of the motion can also identify invalid motion estimation.

In some aspects, extrapolating frames based on inaccurate motion estimation can produce corrupted frame content. For instance, frame extrapolation using inaccurate motion estimation can produce specific types of corruption, e.g., wobbling corruption. For example, during a fade transition between two static images, the human eye can determine that there is no motion in the content. However, as motion estimation may indicate that motion is present, frame extrapolation can produce wobbling corruption in the display, e.g., alternating between clean rendered frames with no motion and extrapolated frames from the erroneous motion estimation. This alternating between disparate frames can produce a wobbling effect across the image. As these types of effects can be unpleasing to viewers of display content, it is important to determine whether motion estimation is accurate.

Some types of motion estimation can produce corruption during a mesh-based frame extrapolation. In some aspects, even legitimate motion estimation can produce frame extrapolation corruption. For example, when neighboring regions produce strongly contradictory motion estimation, it can result in a corrupted frame extrapolation. In some aspects, conflicting directions of motion, e.g., two types of motion moving into one another, can be difficult to estimate. In some aspects, as frame extrapolation can be implemented by distorting a mesh textured with the previously rendered frame contents, neighboring regions of contradictory motion may cause corruption, e.g., tearing or ripping, as vertices of the mesh move and/or intersect. Accordingly, there is a need to solve the problem of inaccurate motion estimation.

Aspects of the present disclosure can solve the aforementioned problem of inaccurate motion estimation. In some instances, aspects of the present disclosure can determine whether there is inaccurate or invalid motion estimation. If inaccurate motion estimation is recognized, then aspects of the present disclosure can drop or ignore the inaccurate motion estimation. In some aspects, when inaccurate motion estimation is recognized, aspects of the present disclosure can estimate motion using another method, e.g., duplicating a previous frame without extrapolating. For instance, in cases with corrupted motion, it may be preferable to duplicate a frame, rather than to provide inaccurate motion estimation. Accordingly, aspects of the present disclosure can identify inaccurate or invalid motion vectors, and then drop or ignore the bad motion estimation. Indeed, aspects of the present disclosure can identify the motion estimation, and use the motion estimation if it is accurate, but drop or ignore the motion estimation if it is inaccurate. In these instances, the present disclosure can copy or use the motion estimation from the previous frame or scene.

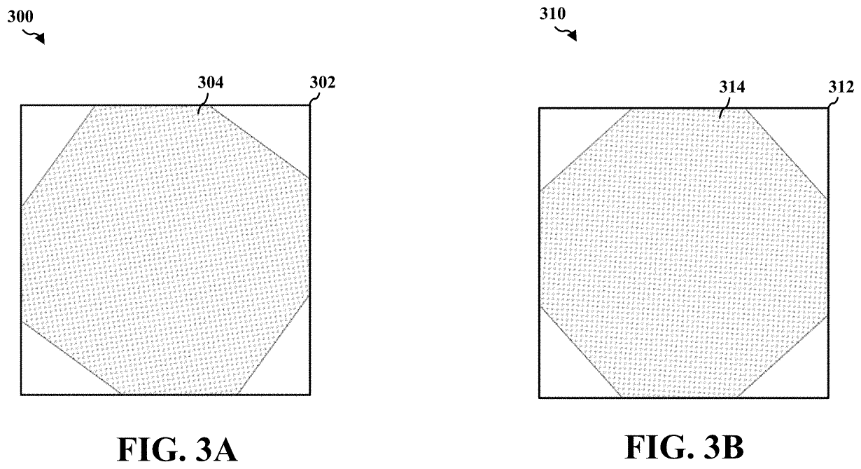

FIGS. 3A and 3B illustrate example content 300 and 310, respectively, including example moving content 304 and 314, respectively, in example frames 302 and 312, respectively. More specifically, FIGS. 3A and 3B display example content on which motion estimation is performed. FIG. 3A shows a frame 302 including moving content 304, e.g., for motion vector determination. For example, the frame 302 and moving content 304 in FIG. 3A are rotated to produce the frame 312 and moving content 314 in FIG. 3B. Aspects of the present disclosure can perform motion estimation based on the moving content 304 and 314 in FIGS. 3A and 3B. For example, in some aspects, the present disclosure can determine the difference in motion value between the moving content 304 and 314 in FIGS. 3A and 3B.

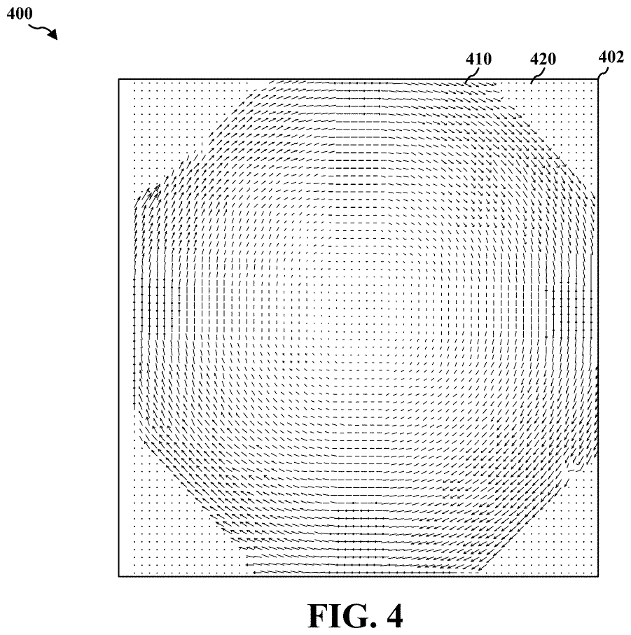

FIG. 4 illustrates motion estimation 400 including motion vectors 410 in frame 402. More specifically, FIG. 4 displays an example of motion vectors 410 resulting from motion estimation 400. As shown in FIG. 4, the motion estimation 400 can include areas with motion vectors 410 including a large motion value, e.g., longer motion vectors near the corners and sides of FIG. 4. Motion estimation 400 can also include areas with motion vectors 410 including a small motion value, e.g., shorter motion vectors near the center of FIG. 4. Also, FIG. 4 displays that motion estimation 400 includes non-motion regions 420, e.g., areas that do not include motion or motion vectors.

Aspects of the present disclosure can also utilize frame extrapolation. In some instances, frame extrapolation can include an existing vector filtering pass, e.g., to smooth the motion estimation and/or improve extrapolation quality. As such, aspects of the present disclosure can perform a filtering pass before utilizing any motion vectors. For example, the present disclosure can filter or analyze the vector data before using this data. This method can also work well along with an existing vector filtering pass. During the existing vector filtering pass, motion regions can be analyzed for deviation from neighboring or adjacent regions. So during the filtering pass, aspects of the present disclosure can analyze the motion estimation and use these statistics to determine if there is accurate or inaccurate motion estimation. Accordingly, aspects of the present disclosure can filter motion vectors before using them, e.g., in order to align with an existing filtering pass.

In some aspects, the present disclosure can analyze motion vectors to determine the amount of deviation. For example, aspects of the present disclosure can measure or determine the amount that two adjacent or neighboring vectors deviate from one another. For instance, once a filtering pass is complete and the motion statistics have been determined, then if there is sufficient total motion, the present disclosure can compare the ratio of regions with deviating motion to the total regions with motion vectors. In some aspects, this ratio can include the ratio of deviating motion regions to the regions including motion, e.g., not including regions without motion. In these aspects, for the areas including motion estimation that have sufficient motion, the present disclosure can determine the ratio of deviating vectors within that motion. Accordingly, aspects of the present disclosure may only consider the motion deviation in regions with motion estimation. This approach can be applied to a total frame or a sub-region of a frame. As such, aspects of the present disclosure can discard the motion vectors in a certain area of the frame, e.g., if there is no motion within that area.

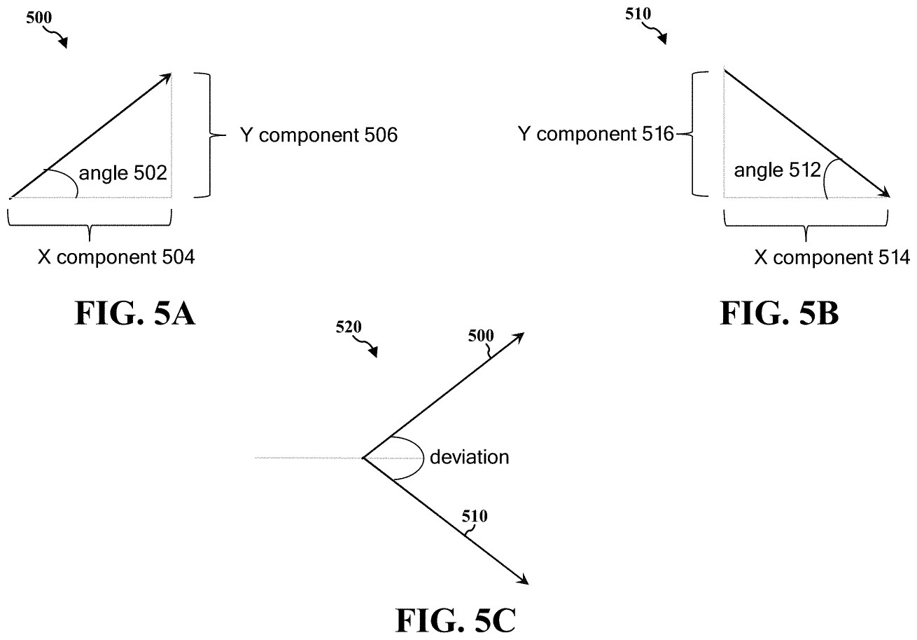

FIGS. 5A-5C illustrate example motion vectors 500 and 510 in accordance with one or more techniques of this disclosure. More specifically, FIGS. 5A-5C illustrate measuring or calculating the deviation between motion vectors 500 and 510. FIG. 5A displays motion vector 500 including angle 502, x component 504, and y component 506. FIG. 5B displays motion vector 510 including angle 512, x component 514, and y component 516. FIG. 5C shows calculation 520 including measuring the motion deviation between motion vector 500 and motion vector 510. Accordingly, FIG. 5C displays that the motion deviation can be measured or calculated by determining the difference in value between two motion vectors.

In some aspects, the present disclosure can determine the amount of blocks or vectors that are in motion. For the blocks or vectors that are in motion, aspects of the present disclosure can determine how much they deviate from their adjacent or neighboring blocks or vectors. In some instances, e.g., if the motion vectors are in a grid over an image, each motion vector is calculated or measured, so the present disclosure can determine is if there is motion in this area. The present disclosure can then use the information regarding how much the motion vector deviates from a neighboring motion vector. Accordingly, aspects of the present disclosure can measure two motion amounts for each vector: the motion value of the vector and the amount the vector deviates from neighboring vectors. In these instances, aspects of the present disclosure can use a normalized amount of motion between two adjacent or neighboring vectors. As such, aspects of the present disclosure can determine the difference between the two vectors to determine whether one vector deviates from another. As the present disclosure cycles through the vectors, these motion differences or deviation amounts can be recorded.

In some aspects, once a filtering pass completes, in order to determine if the motion estimation is valid, the present disclosure can determine whether there is sufficient total motion within a frame. For instance, the ratio of regions including deviating adjacent vectors to total motion regions can be used to indicate if the frame includes usable or unusable motion estimation. If there is insufficient total motion, then aspects of the present disclosure may not utilize the ratio of deviating motion regions to total motion regions. Therefore, aspects of the present disclosure can first determine if there is sufficient overall motion, and then determine the amount of motion vectors that deviate from adjacent or neighboring motion vectors. If this amount exceeds a certain threshold, then the present disclosure can determine that this region of the frame may have invalid motion estimation. Otherwise, if this amount does not cross a threshold, then the motion estimation may be valid. As mentioned above, the deviation of neighboring vectors can be determined by calculating the direction of a motion region from the x or y motion vector components and determining whether the difference in direction of the two regions exceeds a certain threshold.

In some implementations, the present disclosure may distinguish usable from unusable motion estimation results with a high degree of accuracy. For instance, invalid motion estimation can be detected while legitimate motion may be allowed to be processed, e.g., as it may not add excessive overhead. In some aspects, when the motion estimation is determined to be unusable, a frame extrapolation implementation can produce a number of different results. For example, unusable motion estimation can cause the frame extrapolation to abort producing an extrapolated frame, extrapolate a duplicate frame with no motion component, and/or use another source of approximate motion estimation, e.g., the motion estimation results from a previous frame.

As mentioned above, aspects of the present disclosure can detect invalid or inaccurate motion estimation. In some aspects, motion estimations according to the present disclosure can be easy to implement, accurate, and/or fit within an existing filtering loop. In some instances, during a filtering pass, the present disclosure can determine or count the number of blocks or vectors in motion and/or determine or count the number of motion deviations. As mentioned herein, aspects of the present disclosure can calculate multiple motion statistics, such as the amount of blocks or vectors that are in motion, and for the blocks or vectors in motion, the amount of deviation from the neighboring or adjacent blocks. After filtering, if there is sufficient overall motion, aspects of the present disclosure can use the ratio of deviation blocks to blocks in motion, e.g., to determine the validity of the motion estimation.

As indicated herein, some aspects of the present disclosure can estimate motion vectors in a frame. In some instances, the present disclosure can estimate motion by analyzing motion vectors. In further aspects, the present disclosure can estimate motion for an entire frame or a sub-region of a frame. Additionally, aspects of the present disclosure can determine whether there is sufficient overall motion in a frame. In some aspects, the present disclosure can determine whether a motion estimation exceeds a threshold and/or compare the motion of each vector in the frame. If there is not sufficient overall motion, e.g., the motion is less than a threshold, then the motion estimation may be valid. If there is sufficient overall motion, the present disclosure can determine whether the deviation is over a ratio limit, e.g., by comparing neighboring vectors. If the deviation is less than a ratio limit, then the motion estimation may be valid. If the deviation is greater than or equal to a ratio limit, then the motion estimation may be invalid. If the motion estimation is invalid, the present disclosure may ignore or not use the motion estimation, or use motion estimation from a previous frame.

As further mentioned above, aspects of the present disclosure can filter the motion vectors in the frame, e.g., through a filtering pass. For instance, aspects of the present disclosure can organize certain motion vectors in relation to adjacent or neighboring motion vectors. For example, aspects of the present disclosure can filter motion vectors and then average these motion vectors with neighboring or adjacent motion vectors.

Aspects of the present disclosure can also utilize frame extrapolation. For instance, the present disclosure can distort a mesh based on the motion estimation. By distorting a mesh, this can warp the last rendered frame into position to interpret the value of the next frame. Accordingly, this can result in a pair of frames, as well as motion estimation between the frames. In some instances, aspects of the present disclosure may extrapolate the next frame. For example, the present disclosure may transform the image in the second frame in order to warp it into what the motion estimation determined should be the region for each frame. In some aspects, this can be accomplished with a mesh distortion rendering pass. For instance, the present disclosure can use the last rendered frame as a texture on top of a mesh across the top of the screen, e.g., to produce the same frame. As such, the motion estimation can be block based such that a motion vector corresponds to a certain amount of pixels, e.g., one motion vector for eight pixels.

Additionally, aspects of the present disclosure can set up a mesh across a frame, and then use the motion vectors to move the mesh across the frame. Accordingly, aspects of the present disclosure can distort the mesh based on the motion estimation. In turn, this can warp the texture, e.g., the last rendered frame, into position and help to interpret the value of the next frame. In some instances, using a mesh with no motion can result in an output of the previous frame. As such, the mesh can distort the previous frame into position.

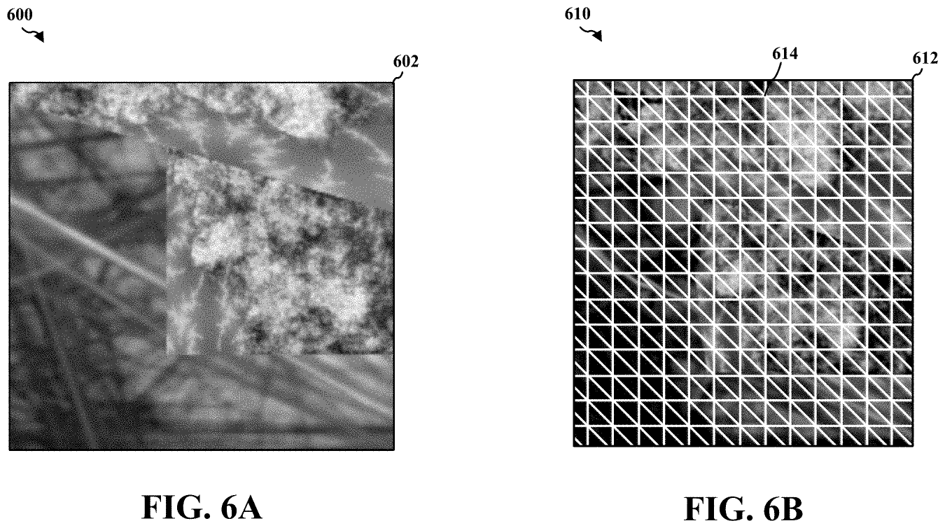

FIGS. 6A and 6B illustrate example frame extrapolations 600 and 610, respectively, in accordance with one or more techniques of this disclosure. More specifically, FIGS. 6A and 6B display an example extrapolation method. As displayed in FIG. 6A, frame extrapolation 600 includes frame 602. FIG. 6B displays frame extrapolation 610 including frame 612 and mesh 614. Also, the direction of motion in FIGS. 6A and 6B is to the left. For instance, FIG. 6A shows that the previous content is moving to the left. FIG. 6B adds a mesh 614 to estimate the motion and pull the content in the direction of the motion. Accordingly, the mesh 614 helps to distort the image.

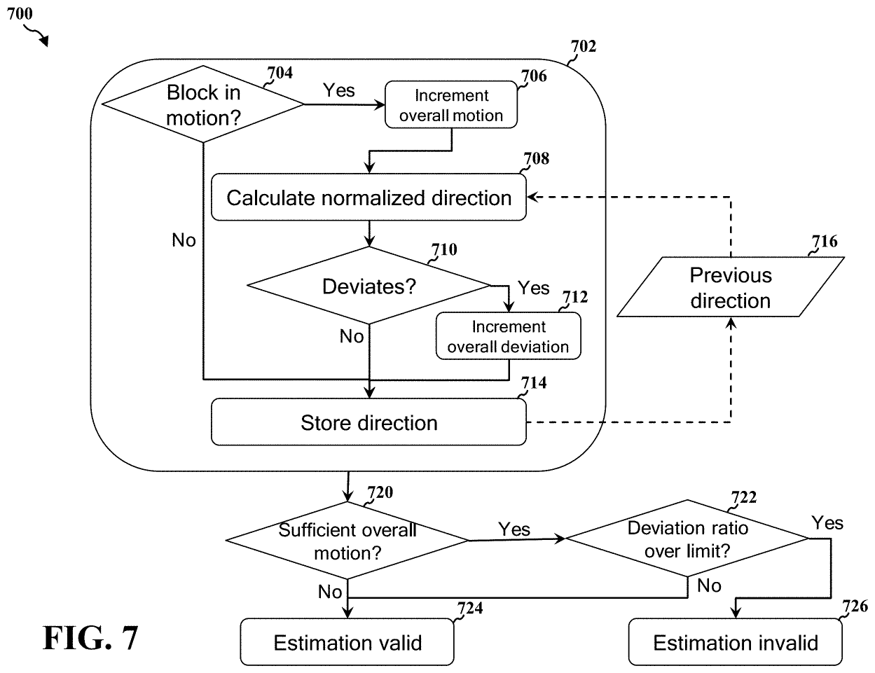

FIG. 7 illustrates an example flowchart 700 of an example method in accordance with one or more techniques of this disclosure. Flowchart 700 includes logic section 702, which includes step 704 that determines whether a block or vector is in motion. If yes, then at step 706 the overall motion in incremented. At step 708, the present disclosure can calculate the normalized direction of the vectors. At step 710, the present disclosure can determine if adjacent motion vectors deviate from one another. If not, the direction of the motion vectors can be stored at step 714. Also, at step 716, the stored direction of the vectors can be compared with the previous direction. If the vectors deviate from one another, then at step 712 the overall deviation can be incremented. Further, if a block or vector is determined to not be in motion at step 704, the overall deviation can be incremented at step 712.

At step 720, the present disclosure determines that if the overall vector motion does not exceed a motion threshold, then the motion estimation can be determined as valid at step 724. If the overall vector motion does exceed a motion threshold, then the present disclosure can determine whether a deviation ratio is over a limit at step 722, e.g., by comparing the motion of neighboring or adjacent vectors. For instance, the present disclosure can compare neighboring vectors to determine if the motion deviation between the neighboring vectors exceeds a motion ratio limit. If the motion deviation between neighboring vectors does not exceed a motion ratio limit, then the motion estimation can be determined as valid. However, if the motion deviation between neighboring vectors exceeds a motion ratio limit, then the motion estimation can be determined as invalid at step 726. Further, if the motion estimation is invalid, the present disclosure can either abort producing an extrapolated frame, extrapolate a duplicate frame with no motion component, or use another source of approximate motion estimation, e.g., the results of a previous frame.

The logic section 702 of flowchart 700 shows that aspects of the present disclosure can filter the vectors. For example, logic section 702 can be a part of the detection code that is used in an existing filtering pass. Aspects of the present disclosure can also calculate motion statistics while filtering the vectors. For example, the present disclosure can determine the amount of motion across a frame and/or the amount of neighboring motion deviation. Accordingly, this can be an optimization to calculate the statistics in the filtering section. As mentioned previously, determining whether there is sufficient overall motion can refer to the motion estimation of all the motion vectors in the frame. As such, aspects of the present disclosure may determine the magnitude of each vector and/or determine whether a certain threshold is crossed, in order to determine whether a block of vectors is sufficiently moving. If there is sufficient movement, then the present disclosure can determine if the motion estimation is valid or invalid. Additionally, the motion vectors can be estimated with certain systems, e.g., video processing systems, that can be processed on the GPU or the CPU.

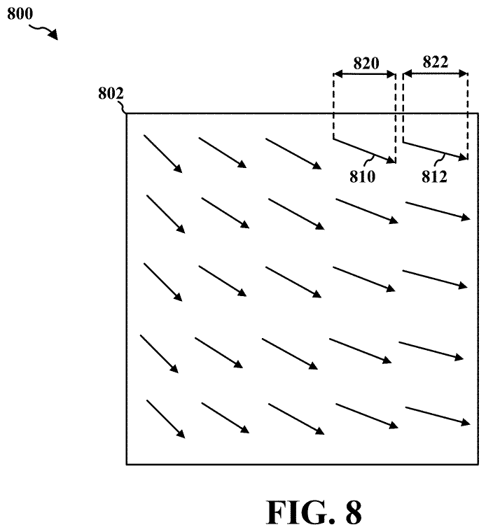

FIG. 8 illustrates motion estimation 800 including motion vectors, e.g., motion vector 810 and motion vector 812, in a frame 802. As shown in FIG. 8, motion vector 810 includes motion value 820 and motion vector 812 includes motion value 822. FIG. 8 illustrates one example of the aforementioned process for determining the validity of motion estimation. As shown in FIG. 8, aspects of the present disclosure, e.g., GPUs herein, can perform a number of different steps or processes to determine whether motion estimation is valid. For instance, aspects of the present disclosure can determine whether motion estimation, e.g., motion estimation 800, for image data in a frame, e.g., frame 802, is greater than or equal to a motion estimation threshold.

As shown in FIG. 8, aspects of the present disclosure can generate a plurality of motion vectors, e.g., motion vectors 810 and 812, in a frame, e.g., frame 802. Aspects of the present disclosure can also estimate a motion value for each of the plurality of motion vectors in the frame, e.g., motion values 820 and 822 for motion vectors 810 and 812, respectively. GPUs herein can also determine whether motion estimation, e.g., motion estimation 800, for image data in a frame, e.g., frame 802, is greater than or equal to a motion estimation threshold. In some aspects, a plurality of motion vectors in the frame 802 can provide the motion estimation 800, where the plurality of motion vectors can include a first motion vector 810 and a second motion vector 812. GPUs herein can also determine a motion value for each of the plurality of motion vectors in the frame 802, e.g., motion values 820 and 822 for motion vectors 810 and 812, respectively.

Aspects of the present disclosure can also compare the first motion vector, e.g., motion vector 810, and the second motion vector, e.g., motion vector 812, when the motion estimation is greater than or equal to the motion estimation threshold, where the first motion vector 810 can include a first motion value 820 and the second motion vector 812 includes a second motion value 822. GPUs herein can also compare each of the plurality of motion vectors in the frame 802, e.g., motion vector 810, to at least one neighboring vector that is adjacent to the vector, e.g., motion vector 812. Accordingly, the first motion vector 810 can be adjacent to the second motion vector 812. GPUs herein can also determine whether a difference between the first motion value 820 and the second motion value 822 is greater than or equal to a motion value threshold.

In some aspects, the motion estimation 800 can be valid when the motion estimation is less than the motion estimation threshold. Additionally, the motion estimation 800 can be valid when the difference between the first motion value 820 and the second motion value 822 is less than the motion value threshold. In some instances, the motion estimation 800 can be invalid when the difference between the first motion value 820 and the second motion value 822 is greater than or equal to the motion value threshold. Moreover, the motion estimation 800 can correspond to previous motion estimation for image data in a previous frame when the difference between the first motion value 820 and the second motion value 822 is greater than or equal to the motion value threshold. In further aspects, the first motion vector 810 and the second motion vector 812 can be in a subset of the frame 802. In addition, the motion estimation 800 can be determined to be greater than or equal to the motion estimation threshold in a graphics processing pipeline of a GPU.

In some aspects, the aforementioned motion estimation can be implemented in a driver as part of frame extrapolation support, e.g., for gaming or VR/AR applications. In some instances, a debug mode can help to visualize motion estimation. Further, implementations herein can also include a color of overlay which indicates the detected direction of motion. In some aspects, the present disclosure can use code to implement the aforementioned motion estimation. For example, the present disclosure may use the following code for motion estimation:

float lastAngle = 0;
float deviationCount = 0;
float inMotionCount = 0;
float PI = 3.14159;
float deviationThreshold = 0.1;
float motionThreshold = 0.0;
float motionRatioThreshold = 0.25;
float deviationRatioThreshold = 0.5;
for (int loopY = 0; loopY < vectorArrayHeight; loopY++)
{

for (int loopX = 0; loopX < vectorArrayWidth; loopX++)
{

float x = motionVectors[(loopY * vectorArrayWidth) + loopX].xMagnitude;
float y = motionVectors[(loopY * vectorArrayWidth) + loopX].yMagnitude;
if ((x > motionThreshold) ∥

(y > motionThreshold))

{

float hyp = sqrt((x * x) + (y * y));
float angle = (atan2(y / hyp, x / hyp) + PI) / (2 * PI);
float deviation = abs(angle − lastAngle);
deviation = min(deviation, abs((angle + 1.0) − lastAngle));
deviation = min(deviation, abs(angle − (lastAngle + 1.0)));
if (deviation > deviationThreshold) { deviationCount++; }
lastAngle = angle;
inMotionCount++;

}
else
{

lastAngle = 0;

}

}

```
}
float totalCount = vectorArrayHeight * vectorArrayWidth;
if (((inMotionCount / totalCount) > motionRatioThreshold) &&
  ((deviationCount / inMotionCount) > deviationRatioThreshold))
{
  // Mark motion estimation as not usable
}
else
{
  // Motion estimation is usable
}
```

As mentioned above, the aforementioned motion estimation can be accurate and fit efficiently within a filtering pass. The aforementioned motion estimation can also be performed as a separate pass. Also, the motion estimation herein can improve a GPU's resource or data utilization and/or resource efficiency. Moreover, aspects of the present disclosure can improve the motion estimation of a GPU, which can in turn improve the accuracy and efficiency of the GPU. Aspects of the present disclosure can also significantly improve the accuracy of motion estimation. For example, aspects of the present disclosure can identify usable versus unusable motion estimation with a high degree of accuracy, e.g., 93 to 97%.

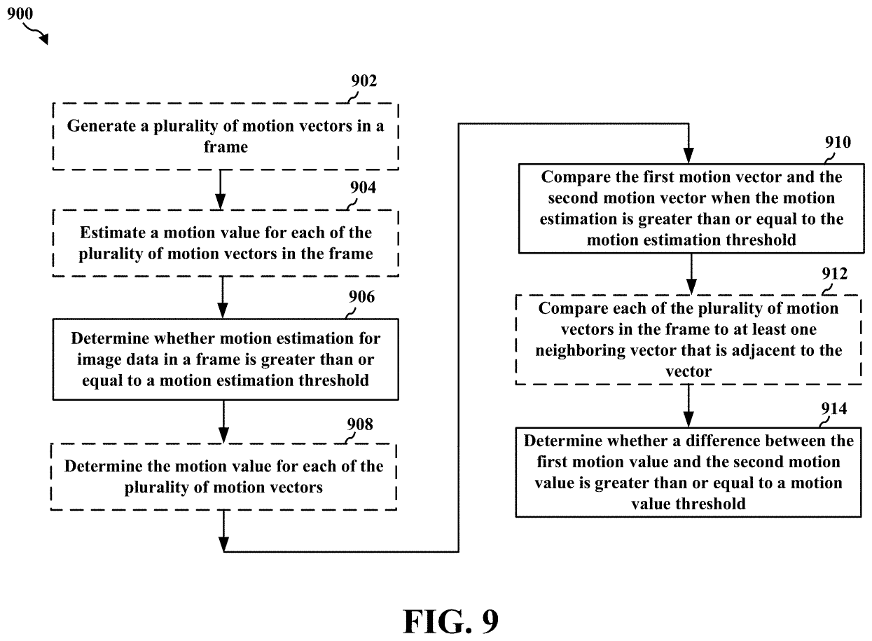

FIG. 9 illustrates an example flowchart 900 of an example method in accordance with one or more techniques of this disclosure. The method may be performed by a GPU or apparatus for graphics processing. At 902, the apparatus can generate a plurality of motion vectors in a frame, as described in connection with the examples in FIGS. 3A, 3B, 4, 5A, 5B, 5C, 6A, 6B, 7, and 8. At 904, the apparatus can estimate a motion value for each of the plurality of motion vectors in the frame, as described in connection with the examples in FIGS. 3A, 3B, 4, 5A, 5B, 5C, 6A, 6B, 7, and 8. At 906, the apparatus can determine whether motion estimation for image data in a frame is greater than or equal to a motion estimation threshold, as described in connection with the examples in FIGS. 3A, 3B, 4, 5A, 5B, 5C, 6A, 6B, 7, and 8. A plurality of motion vectors in the frame can provide the motion estimation, where the plurality of motion vectors can include a first motion vector and a second motion vector, as described in connection with the examples in FIGS. 3A, 3B, 4, 5A, 5B, 5C, 6A, 6B, 7, and 8. At 908, the apparatus can determine a motion value for each of the plurality of motion vectors in the frame, as described in connection with the examples in FIGS. 3A, 3B, 4, 5A, 5B, 5C, 6A, 6B, 7, and 8.

At 910, the apparatus can compare the first motion vector and the second motion vector when the motion estimation is greater than or equal to the motion estimation threshold, where the first motion vector can include a first motion value and the second motion vector includes a second motion value, as described in connection with the examples in FIGS. 3A, 3B, 4, 5A, 5B, 5C, 6A, 6B, 7, and 8. At 912, the apparatus can compare each of the plurality of motion vectors in the frame to at least one neighboring vector that is adjacent to the vector, as described in connection with the examples in FIGS. 3A, 3B, 4, 5A, 5B, 5C, 6A, 6B, 7, and 8. In some aspects, the first motion vector can be adjacent to the second motion vector, as described in connection with the examples in FIGS. 3A, 3B, 4, 5A, 5B, 5C, 6A, 6B, 7, and 8. At 914, the apparatus can determine whether a difference between the first motion value and the second motion value is greater than or equal to a motion value threshold, as described in connection with the examples in FIGS. 3A, 3B, 4, 5A, 5B, 5C, 6A, 6B, 7, and 8.

In some aspects, the motion estimation can be valid when the motion estimation is less than the motion estimation threshold, as described in connection with the examples in FIGS. 3A, 3B, 4, 5A, 5B, 5C, 6A, 6B, 7, and 8. Additionally, the motion estimation can be valid when the difference between the first motion value and the second motion value is less than the motion value threshold, as described in connection with the examples in FIGS. 3A, 3B, 4, 5A, 5B, 5C, 6A, 6B, 7, and 8. In some instances, the motion estimation can be invalid when the difference between the first motion value and the second motion value is greater than or equal to the motion value threshold, as described in connection with the examples in FIGS. 3A, 3B, 4, 5A, 5B, 5C, 6A, 6B, 7, and 8. Moreover, the motion estimation can correspond to previous motion estimation for image data in a previous frame when the difference between the first motion value and the second motion value is greater than or equal to the motion value threshold, as described in connection with the examples in FIGS. 3A, 3B, 4, 5A, 5B, 5C, 6A, 6B, 7, and 8. In further aspects, the first motion vector and the second motion vector can be in a subset of the frame, as described in connection with the examples in FIGS. 3A, 3B, 4, 5A, 5B, 5C, 6A, 6B, 7, and 8. In addition, the motion estimation can be determined to be greater than or equal to the motion estimation threshold in a graphics processing pipeline of a GPU, as described in connection with the examples in FIGS. 3A, 3B, 4, 5A, 5B, 5C, 6A, 6B, 7, and 8.

In one configuration, a method or apparatus for graphics processing is provided. The apparatus may be a GPU or some other processor that can perform graphics processing. In one aspect, the apparatus may be the processing unit 120 within the device 104, or may be some other hardware within device 104 or another device. The apparatus may include means for determining whether motion estimation for image data in a frame is greater than or equal to a motion estimation threshold. The apparatus may also include means for comparing the first motion vector and the second motion vector when the motion estimation is greater than or equal to the motion estimation threshold. The apparatus may also include means for determining whether a difference between the first motion value and the second motion value is greater than or equal to a motion value threshold. The apparatus may also include means for determining a motion value for each of the plurality of motion vectors in the frame. Additionally, the apparatus may include means for comparing each of the plurality of motion vectors in the frame to at least one neighboring vector that is adjacent to the vector. The apparatus may also include means for estimating a motion value for each of the plurality of motion vectors in the frame. Further, the apparatus may include means for generating the plurality of motion vectors in the frame.

The subject matter described herein can be implemented to realize one or more benefits or advantages. For instance, the described graphics processing techniques can be accomplished at a low cost compared to other graphics processing techniques. Moreover, the graphics processing techniques herein can improve or speed up the data processing or execution of GPUs. Further, the graphics processing techniques herein can improve a GPU's resource or data utilization and/or resource efficiency. Additionally, aspects of the present disclosure can improve the motion estimation of a GPU, which can in turn improve the accuracy and efficiency of the GPU. Aspects of the present disclosure can also improve the accuracy of motion estimation. For example, aspects of the present disclosure can identify usable versus unusable motion estimation with an accuracy of 93 to 97%. Further, aspects of the present disclosure can improve the quality and/or accuracy of extrapolated or interpolated frames.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method for graphics processing, comprising:
determining whether motion estimation for image data in a frame is greater than or equal to a motion estimation threshold, a plurality of motion vectors in the frame providing the motion estimation, wherein the plurality of motion vectors includes a first motion vector and a second motion vector;
comparing the first motion vector and the second motion vector when the motion estimation is greater than or equal to the motion estimation threshold, wherein the first motion vector includes a first motion value and the second motion vector includes a second motion value; and
determining whether a difference between the first motion value and the second motion value is greater than or equal to a motion value threshold.

2. The method of claim 1, wherein determining whether the motion estimation is greater than or equal to a motion estimation threshold further comprises:
determining a motion value for each of the plurality of motion vectors in the frame.

3. The method of claim 1, wherein comparing the first motion vector and the second motion vector further comprises:
comparing each of the plurality of motion vectors in the frame to at least one neighboring vector that is adjacent to the vector.

4. The method of claim 1, wherein the first motion vector is adjacent to the second motion vector.

5. The method of claim 1, wherein the motion estimation is valid when the motion estimation is less than the motion estimation threshold.

6. The method of claim 1, wherein the motion estimation is valid when the difference between the first motion value and the second motion value is less than the motion value threshold.

7. The method of claim 1, wherein the motion estimation is invalid when the difference between the first motion value and the second motion value is greater than or equal to the motion value threshold.

8. The method of claim 7, wherein the motion estimation corresponds to previous motion estimation for image data in a previous frame when the difference between the first motion value and the second motion value is greater than or equal to the motion value threshold.

9. The method of claim 1, wherein the first motion vector and the second motion vector are in a subset of the frame.

10. The method of claim 1, further comprising:
estimating a motion value for each of the plurality of motion vectors in the frame.

11. The method of claim 1, further comprising:
generating the plurality of motion vectors in the frame.

12. The method of claim 1, wherein the motion estimation is determined to be greater than or equal to the motion estimation threshold in a graphics processing pipeline of a graphics processing unit (GPU).

13. An apparatus for graphics processing, comprising:
a memory; and
at least one processor coupled to the memory and configured to:
determine whether motion estimation for image data in a frame is greater than or equal to a motion estimation threshold, a plurality of motion vectors in the frame providing the motion estimation, wherein the plurality of motion vectors includes a first motion vector and a second motion vector;
compare the first motion vector and the second motion vector when the motion estimation is greater than or equal to the motion estimation threshold, wherein the first motion vector includes a first motion value and the second motion vector includes a second motion value; and
determine whether a difference between the first motion value and the second motion value is greater than or equal to a motion value threshold.

14. The apparatus of claim 13, wherein to determine whether the motion estimation is greater than or equal to a motion estimation threshold further comprises the at least one processor configured to:
determine a motion value for each of the plurality of motion vectors in the frame.

15. The apparatus of claim 13, wherein to compare the first motion vector and the second motion vector further comprises the at least one processor configured to:
compare each of the plurality of motion vectors in the frame to at least one neighboring vector that is adjacent to the vector.

16. The apparatus of claim 13, wherein the first motion vector is adjacent to the second motion vector.

17. The apparatus of claim 13, wherein the motion estimation is valid when the motion estimation is less than the motion estimation threshold.

18. The apparatus of claim 13, wherein the motion estimation is valid when the difference between the first motion value and the second motion value is less than the motion value threshold.

19. The apparatus of claim 13, wherein the motion estimation is invalid when the difference between the first motion value and the second motion value is greater than or equal to the motion value threshold.

20. The apparatus of claim 19, wherein the motion estimation corresponds to previous motion estimation for image data in a previous frame when the difference between the first motion value and the second motion value is greater than or equal to the motion value threshold.

21. The apparatus of claim 13, wherein the first motion vector and the second motion vector are in a subset of the frame.

22. The apparatus of claim 13, further comprising the at least one processor configured to:
estimate a motion value for each of the plurality of motion vectors in the frame.

23. The apparatus of claim 13, further comprising the at least one processor configured to:
generate the plurality of motion vectors in the frame.

24. The apparatus of claim 13, wherein the motion estimation is determined to be greater than or equal to the motion estimation threshold in a graphics processing pipeline of a graphics processing unit (GPU).

25. An apparatus for graphics processing, comprising:
means for determining whether motion estimation for image data in a frame is greater than or equal to a motion estimation threshold, a plurality of motion vectors in the frame providing the motion estimation, wherein the plurality of motion vectors includes a first motion vector and a second motion vector;
means for comparing the first motion vector and the second motion vector when the motion estimation is greater than or equal to the motion estimation threshold, wherein the first motion vector includes a first motion value and the second motion vector includes a second motion value; and
means for determining whether a difference between the first motion value and the second motion value is greater than or equal to a motion value threshold.

26. The apparatus of claim 25, wherein the means for determining whether the motion estimation is greater than or equal to a motion estimation threshold is further configured to:
determine a motion value for each of the plurality of motion vectors in the frame.

27. The apparatus of claim 25, wherein the means for comparing the first motion vector and the second motion vector is further configured to:
compare each of the plurality of motion vectors in the frame to at least one neighboring vector that is adjacent to the vector.

28. The apparatus of claim 25, wherein the motion estimation is valid when the motion estimation is less than the motion estimation threshold or when the difference between the first motion value and the second motion value is less than the motion value threshold.

29. The apparatus of claim 25, wherein the motion estimation is invalid when the difference between the first motion value and the second motion value is greater than or equal to the motion value threshold, wherein the motion estimation corresponds to previous motion estimation for image data in a previous frame when the difference between the first motion value and the second motion value is greater than or equal to the motion value threshold.

30. A computer-readable medium storing computer executable code for graphics processing, comprising code to:
determine whether motion estimation for image data in a frame is greater than or equal to a motion estimation threshold, a plurality of motion vectors in the frame providing the motion estimation, wherein the plurality of motion vectors includes a first motion vector and a second motion vector;
compare the first motion vector and the second motion vector when the motion estimation is greater than or equal to the motion estimation threshold, wherein the first motion vector includes a first motion value and the second motion vector includes a second motion value; and
determine whether a difference between the first motion value and the second motion value is greater than or equal to a motion value threshold.
